(19) United States
(12) Patent Application Publication
(10) Pub. No.: US 2005/0053174 A1
(43) Pub. Date: Mar. 10, 2005

(54) Device and method for data reproduction

(75) Inventors: Hyun-Soo Park, Seoul (KR); Jae-Wook Lee, Gyeonggi-do (KR); Eun-Jin Ryu, Gyeonggi-do (KR); Jae-Seong Shim, Seoul (KR); Eing-Seob Cho, Gyeonggi-do (KR); Jung-Hyun Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/869,851

(22) Filed: Jun. 18, 2004

(30) Foreign Application Priority Data
Sep. 9, 2003 (KR) 2003-63360

(51) Int. Cl. H04B 1/10

(52) U.S. Cl. 375/341

(57) ABSTRACT

A device and method for data reproduction of an optical disk generating an optimized reference level optimizing a channel characteristic, the device includes a channel identifier which receives an input signal of an equalizer and detects an optimum level, and an adaptation process which by using the detected optimum level, updates the coefficient of the equalizer. Accordingly, the data reproduction device and method can detect a reference level value capable of maximizing the performance of a viterbi decoder and limit noise caused by tilt and other effects that may occur by the shape of a disk or a pickup apparatus.

### CROSS-REFERENCE TO RELATED APPLICATION

This application claims the benefit of Korean Patent Application No. 2003-63360, filed on Sep. 9, 2003 in the Korean Intellectual Property Office, the disclosure of which is incorporated herein by reference.

### BACKGROUND OF THE INVENTION

1. Field of the Invention

The present invention relates to a data reproduction device and method using viterbi decoding, and more particularly, to a data reproduction device and method that can achieve a reference level optimizing the characteristic of a channel and can be applied to the reproduction of data on an optical disk.

2. Description of the Related Art

In an optical disk, a binary signal is recorded on the surface of the disk and by reading a reflected waveform from the disk when applying a laser beam, the original binary signal is reproduced. The signal read from the surface of the disk is referred to as a radio frequency (RF) signal. The RF signal has a characteristic of an analog signal due to the physical and optical characteristics of the disk. Accordingly, the analog signal should be converted into a digital signal and this conversion requires binarization and a phase locked loop (PLL) process. A variety of binarization mechanisms are available, and among the binarization mechanisms, a viterbi decoder is known as a decoding apparatus capable of obtaining a binary signal having the least errors. Also, the viterbi decoder is known to be capable of detecting a binary signal in an optimal condition to suit the characteristic of a channel and to have better performance than that of a simple sign detection circuit or a run length correction method.

Examples of detectors having a viterbi decoder are well explained in Korean Patent Application No. 2000-56149, “Selective disturbance compensation apparatus and method in reproducing data on an optical recording medium”, and in Korean Patent Application No. 1998-49542, “Data reproduction device.”

FIG. 1 is a block diagram of a conventional art data reproduction apparatus having a viterbi decoder. An analog signal 101 read from an optical disk (not shown) is converted into a quantized digital signal 102, by being sampled and held by a digital-to-analog converter 110. An offset cancellation unit 120 compensates the DC component of the quantized digital signal 102 using an offset signal 103. An equalizer is usually implemented by a finite impulse response (FIR) filter 130 and amplifies each input signal 104, which is the digital signal 102 compensates by the offset signal 103, that is delayed and then input, in a predetermined frequency band so that the characteristic of a channel becomes clear. Since a branch metric generator (not shown) inside a viterbi decoder 140 generates a state metric by obtaining the difference between each reference level and an actual input signal 105, a reference level 107 input to the viterbi decoder 140 has a great influence on the performance of the viterbi decoder 140. However, due to the physical characteristic of a disk and situational changes, a reference level 107 having an optimal condition for a signal input 105 from each medium is different, and a reference level 107 maximizing the performance of the viterbi decoder 140, should be determined.

One method to solve the above problem is to add a level detector 150 to the apparatus, as shown in FIG. 1. This method or device is disclosed in detail in Korean Patent No. 2000-00965. The level detector 150 generates an optimum reference level 107 which is input to the viterbi decoder 140 from the output 105 of the FIR filter 130. The level detector 150 determines one of reference levels 107 used in the viterbi decoder 140, including ± maximum level, ± medium level, and zero level, by monitoring the output 105 of the equalizer 130. Then, by using the determined value as a determined level of the viterbi decoder 140, the error ratio of data bits is reduced and the data detection 106 performance is improved. Each of the components 110, 120, 130, 140, 150 receives a signal 109 from a phase locked loop unit 160, which phase loop locks the input signal 104.

However, in the conventional data reproduction device in FIG. 1, an optimum reference level is selected by selecting a signal 107 having a predetermined level, such as ± maximum level and ± medium level. Accordingly, if noise occurs in a determined level, this level 107 does not correspond to the original reference level, but to another level, causing serious problems in the decoding procedure. Generally, the higher the recording density of an optical disk, the lower the quality of a signal 106 reproduced. Generally, tangential tilt or radial tilt caused by deformation of a disk substrate or a pickup apparatus creates noise in this high recording density disk, and the increasing error ratio due to this noise causes more serious problems in an ordinary disk reproduction device.

### SUMMARY OF THE INVENTION

An aspect of the present invention provides a data reproduction device and method by which a reference level capable of optimizing the performance of a viterbi decoder by optimally determining the signal characteristics of a variety of optical disks is determined, and which limits noise such as the one caused by tangential tilt.

According to an aspect of the present invention, there is provided a data reproduction device having a viterbi decoder, including: an equalizer which equalizes a predetermined frequency of an input signal; a channel identifier which, based on the input signal of the equalizer, detects a reference level of the viterbi decoder; and an adaptation processor which based on the detected reference level, and an input signal and an output signal of the equalizer, determines a filtering coefficient of the equalizer.

According to an aspect of the present invention, the channel identifier detects the reference level based on an input signal of the equalizer which is input for a predetermined time period.

According to an aspect of the present invention, the channel identifier detects the reference level, by obtaining a mean value of the input signal of the equalizer and a previous reference level value.

According to an aspect of the present invention, the channel identifier includes: a selection signal generator which generates a selection signal from an output signal of the viterbi decoder; a level selector which selects a level to be detected from an input signal of the equalizer according to the selection signal; and a mean value filter which for the selected level, generates a new level value based on a previous level value and the level value of an input signal input in the selected level.

According to an aspect of the present invention, the selection signal generator generates a selection signal by multiplexing a signal obtained by delaying the output signal of the viterbi decoder for the same number of clock signals as the number of taps of the viterbi decoder.

According to an aspect of the present invention, the mean filter detects the reference level value according to the following equation: reference level value=previous level value+(delayed input signal−previous level value)/constant

According to an aspect of the present invention, the adaptation processor detects a reference level according to a least mean square (LMS) method.

According to an aspect of the invention, the adaptation processor determines a new coefficient of the equalizer, based on a difference between an output signal of the equalizer and a detected level.

According to an aspect of the invention, the adaptation processor determines the coefficient of the equalizer according to the following equation:
W_{K+1}=Wₖ+2μ eₖ Xₖ
where W_{K+1} denotes a new coefficient of the equalizer, Wₖ denotes a previous coefficient of the equalizer before update, μ denotes a follow-up speed, eₖ denotes an error signal (error signal=detected level value−output of equalizer), and Xₖ denotes an input signal of the equalizer. According to another aspect of the present invention, there is provided a data reproduction method using viterbi decoding by a viterbi decoder, including: equalizing a predetermined frequency of an input signal by using an equalizer; based on the input signal of the equalizer, detecting a reference level of the viterbi decoder in identifying a channel; and based on the detected reference level, and an input signal and an output signal of the equalizer, determining a filtering coefficient of the equalizer in generating a coefficient according to another aspect of the present invention, the identification of a channel includes: detecting the reference level based on an input signal of the equalizer which is input for a predetermined time period.

According to another aspect of the present invention, the identification of a channel includes: generating a selection signal from an output signal of the viterbi decoder; selecting a level to be detected from an input signal of the equalizer according to the selection signal; and for the selected level, generating a new level value based on a previous level value and the level value of an input signal input in the selected level, in detecting a level value.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent and more readily appreciated by describing in detail exemplary embodiments thereof with reference to the attached drawings in which:

FIG. 1 is a block diagram of a conventional data reproduction apparatus having a viterbi decoder;

FIG. 2 is a diagram showing a data reproduction device according to an embodiment of the present invention;

FIG. 3 is a diagram showing the internal structure of a channel identifier according to an embodiment of the present invention;

FIG. 4 is a Trellis diagram of a 5-tap viterbi decoder using (1,7) code of an embodiment of the present invention;

FIG. 5 is a diagram showing the result of level estimation when an embodiment of the present invention is operated in the viterbi decoder of FIG. 4;

FIGS. 6 and 7 are diagrams showing the degree of signal error ratio (SER) by two types of tilts when an embodiment of the present invention is used.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

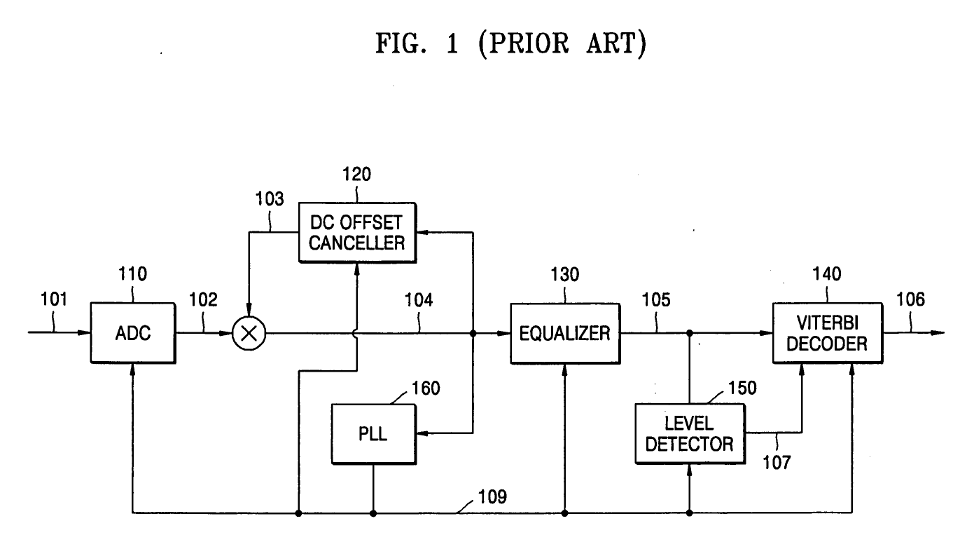

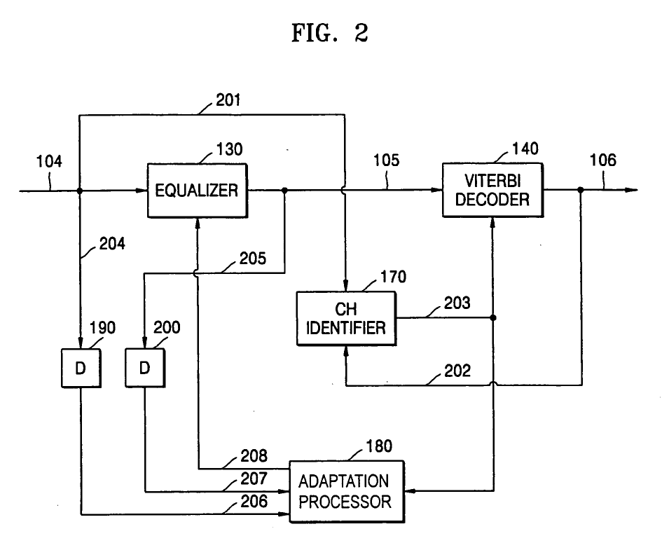

FIG. 2 is a block diagram of a data reproduction device according to an embodiment of the present invention. For simplicity, the digital-analog converter 110, the DC offset cancellation unit 120, and a phase locked loop unit 160 are not shown in FIG. 2, but are understood to be the same as the corresponding parts shown in FIG. 1. The input signal 104 of the equalizer 130 will be explained first.

The embodiment of the present invention shown in FIG. 2 includes a channel identifier 170 and an adaptation processor 180. The channel identifier 170 is similar to the level detector 150 of FIG. 1. However, while only the input signal 105 of the level detector 150 is the output signal 105 of the equalizer 130, the inputs of the channel identifier 170 are the input signal 104 (201 or 204) of the equalizer 130, and the output signal 106 (202) of the viterbi decoder 140. In order to generate an estimated level value 203, the input signal 104 (201 or 204) of the equalizer 130, instead of the output signal 105 (205) of the equalizer 130, is used so that the reproduction error caused by tilt can be reduced when data on the optical disk is reproduced.

Also, the channel identifier 170 is used to estimate the level of the output signal 106 (202) of the viterbi decoder 140, to generate a selection signal to determine which level is to be estimated.

The shown embodiment of the present invention of FIG. 2 also includes an adaptation processor 180. The adaptation processor 180 has as inputs a level estimation value 203, that is the output signal of the channel identifier 170, a delayed input signal 206 and a delayed output signal 207 of the equalizer 130. Using the input signals 203,206,207, the adaptation processor 180 generates an updated coefficient 208, that is, the adaptation processor 180 adapts the filtering coefficient of the equalizer 130.

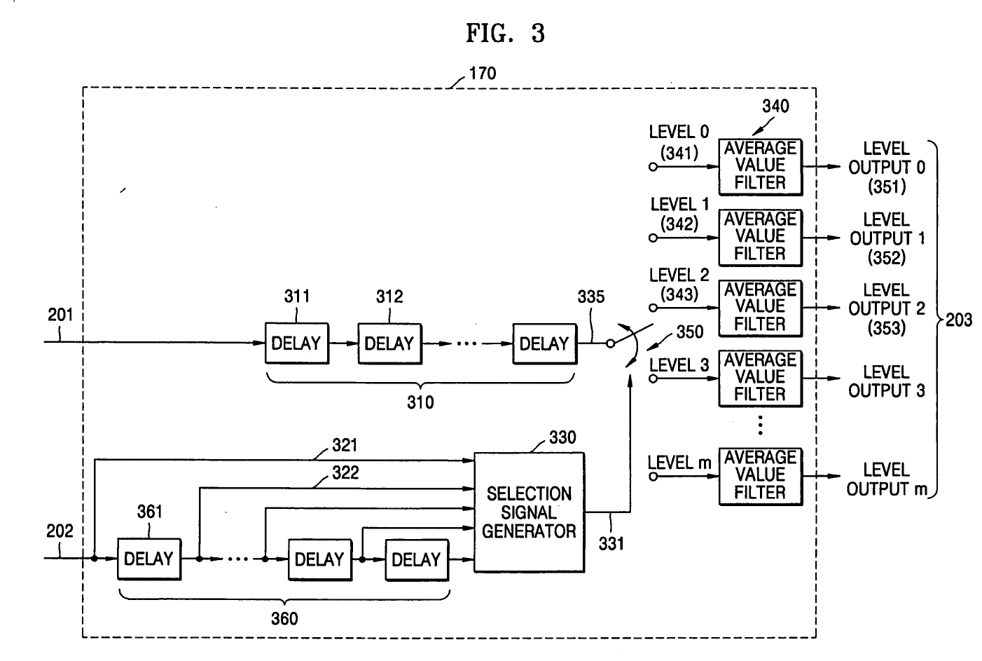

The operation principles of the channel identifier 170 and the adaptation processor will now be explained in using the embodiment shown in FIG. 3. FIG. 3 is a diagram showing the internal structure of a channel identifier 170 according to an embodiment of the present invention. The channel identifier 170 includes a selection signal generator 330, a level selector 350, and a mean filter 340. The selection signal generator 330 receives the output signal 202 of a viterbi decoder 140 and generates a selection signal 331. As shown, the output signal 202 of the viterbi decoder 140 is a binary signal having any one value of 0 and 1, and is a final output decoded by the viterbi decoder 140. According to the operation principle of the viterbi decoder 140, the output signal of the viterbi decoder 140 is related to the input signal 105 of the viterbi decoder 140, that is, the output signal 105 (205) of the equalizer 130. In other words, the output signal 106 (203) of the viterbi decoder 140 can determine the type of the level input to the viterbi decoder 140.

An example will now be explained. When a signal level is generated by PR (1,2,1) and the code type is (1,7), idealistic level values that can occur are 4, 2, −2, 4. If the levels of an input signal are 4, 4, 4, 2, −2, 4, 4, 4, −2, 2, the output signals of the viterbi decoder will be 1, 1, 1, −1, −1, −1, −1, −1, 1, 1. At this time, if the same number of output signals of the viterbi decoder 140 as the number of taps of the viterbi decoder 140 are multiplexed, the outputs will be 111,11−1, 1−1−1, −1−1−1, . . . , and if represented in a binary signal, the outputs will be 111, 110, 100, 000, . . . . Accordingly, these binary signals indicate that 4, 2, −2, −4, . . . , are input, respectively, such that 111, 110, 100, 000, . . . , can be used as selection signals to determine the type of the level value such as 4, 2, −2, 4, . . . .

The output signal 202 (106) of the viterbi decoder 140 is input to the channel identifier 170 and is delayed by the same number of delay units 361, . . . , as the number of taps of the viterbi decoder −1, divided, and input to the selection signal generator 330. The delayed input signals 321, 322, . . . , are combined by the selection signal generator 330 to generate a selection signal 331 in the form of a binary signal. For example, when the number of taps of the viterbi decoder 140 is 3, the number of delays 361 is 2, then the forms of selection signal include 111, 110, 100, 000, . . . . The reason for using the delays 361, . . . , is that the output signal 202 (106) of the viterbi decoder 140 is not immediately output. That is, the output signal 202 (106) of the viterbi decoder 140 is output after predetermined system clocks of operation. Therefore, in order to select an input signal 201 (104) corresponding to the output signal 202 (106) of the viterbi decoder 140, the delay time corresponding to the operation should also be allocated to the input signal 202 (106) of the channel identifier 17. Also, the selection signal 331 can be removed when it corresponds to a viterbi path that is removable according to the condition of a shortest signal. For example, in the case of a 3-tap structure viterbi decoder using (1,7) code, selection signals 331 of 010 and 101 corresponding to 1T are removed and 6 selection signals, including 000, 001, 01, 100, 1110, and 111, are available. Likewise, in the case of a 5-tap structure viterbi decoder using (1,7) code, only 16 levels are needed and the number of selection signals that are generated is also 16. If the output of the viterbi decoder is a correct one, 1T signal is not generated in the output signal itself of the viterbi decoder and therefore a separate part for generation of a selection signal is not needed.

Another input signal of the channel identifier 170 is the input signal 201. The input signal 201 is an electrical signal having an analog value and is an object of decoding. This signal 201 has an actual value having a difference from an idealistic reference level. The input signal 201 of the identifier is input to the level selector 350 through the same number of delay units 311, 312, . . . , as the number (M) of memories of the viterbi decoder, and outputs a delayed input signal 335. The level selector 350 transfers the input signal 335 of the channel identifier to a mean filter 340 corresponding to each level, based on the selection signal 331. Mean filters 340 correspond to respective levels of the viterbi decoder 140. Accordingly, the number of mean filters 340 is the same as the number of levels of the connected viterbi decoder 140. Also, unnecessary paths can be removed.

Each mean filter 340 obtains a mean value of selected signals 341, 342, 343, . . . , for a predetermined time, and outputs the mean value as a new level value 351, 352, 353, . . . . As shown, the mean filter 340 includes a plurality of filters 340. Generally, a low pass filter can be used as the mean value filter 340. The characteristic of the low pass filter which follows-up a DC mean value is used. Another form of obtaining a mean value through the mean filter 340 is to use the following equation 1:
L′=L+(I−L)/C (1)

Here, L′ denotes a level value 351, 352, . . . , which is updated by a newly input signal, L denotes a previous level value, I denotes a delayed input signal 341, 342, 343 . . . , and C denotes a constant. The higher the value of constant C, the less the change in degree of level L′, and in the degree of follow-up.

Referring again to FIG. 3, the detected new level 351, 352, 353 . . . , is input to the adaptation processor 180 shown in FIG. 1 as signal 203. The adaptation processor 180 generates a new coefficient 208 of the equalizer 130 based on the detected level error. The detected level error is the difference of the output signal 205 (105) of the equalizer 130 and the detected level 203. For the new coefficient 208 of the equalizer 130, a method of updating a previous coefficient by using a least mean square (LMS) method is used according to an aspect of the invention. For example, an equation which can be used is as equation 2:
W_{K+1}=Wₖ+2μ eₖ Xₖ (2)

Here, W_{K+1} denotes the new coefficient 208 of the equalizer 130, Wₖ denotes the previous coefficient of the equalizer 130, μ denotes a follow-up speed (real number), eₖ denotes an error signal and is a value obtained by subtracting the output signal 205 (105) of the equalizer 130 from the detected level value 208, and Xₖ denotes the input signal 204 of the equalizer.

As shown in FIG. 2, the input signal Xₖ 204 (104) is delayed by the delay unit 190, and the delayed signal 206 is input to the adaptation processor 180. This is because the adaptation processor 180 needs predetermined clocks of delay to obtain the level error eₖ. Similarly, the output signal 205 (105) of the equalizer 130 is delayed for a predetermined time by the delay unit 200, and the delayed signal 204 is input to the adaptation processor 180. This is because there is a time delay for the adaptation processor 180 to detect a new level.

The follow-up speed μ is a parameter determining the degree of follow-up and can be adjusted by a microcomputer (not shown) or other control tools according to aspects of the invention. The higher the value of follow-up speed μ, the more the increase in the degree of level follow-up. This occurs within a range of stability, but if the value is not within the range, it diverges and becomes unstable.

The adaptation processor 180 of an aspect of the present invention is used to stabilize a channel. This is different from the conventional adaptation processor (i.e., the level detector 150), which is used to generate a level value appropriate to a viterbi decoder 140. In the conventional adaptation processor, the level of a viterbi decoder 140 is set to a fixed value and the input signal 104 of an equalizer 130 is changed to a value optimum to the level of the viterbi decoder through the adaptation processor. However, in the shown embodiment of the present invention, the channel identifier 170 generates an optimum level of the viterbi decoder 140 based on the input signal 201 (104 or 204) of the equalizer 130. In addition, by readjusting the coefficient of the equalizer 130, (that is, the filter,) and by using an analyzed optimum level, the adaptation processor 180 removes only noise such that the output signal 105 (205) of the equalizer 130 can keep almost all the frequency characteristic of the original channel. This process provides higher stability for the stabilization of LMS algorithm coefficients and divergence that have been problematic.

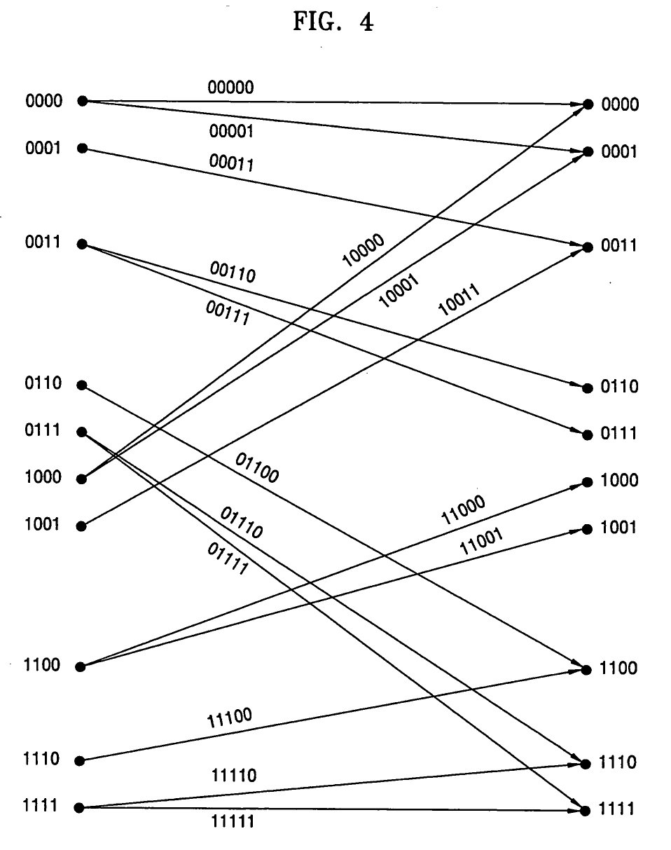

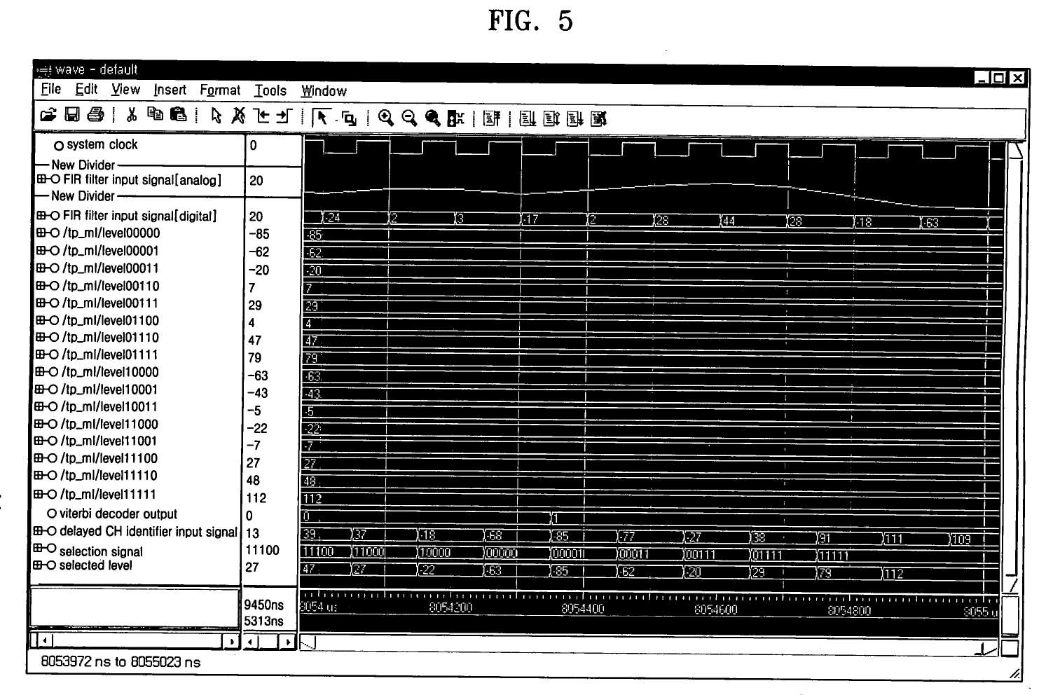

FIG. 4 is a Trellis diagram of a 5-tap viterbi decoder 140 using (1,7) code of an aspect of the present invention, and FIG. 5 is a diagram showing the result of level estimation when an aspect of the present invention operates in the viterbi decoder 140 of FIG. 4.

Referring to FIG. 4, it can be seen that a path when 1T signal is input is removed. Accordingly, the number of paths is 16 in total and therefore, the number of levels is 16.

Referring to FIG. 4, 16 idealistic levels (00000, 00001, 00011, 00110, 00111, . . . ) are shown. Also, signals 201 input to the channel identifier 170 are 39, 37, −18, −68, . . . , and at this time, selection signals are 11100, 11000, 10000, 00000, 00001, . . . , and the number of selection signals 331 is the same as the number of levels. If a level being operated is selected according to a selection signal 331, selected level signals will be 47 (in case of 11100), 27 (in case of 11000), −22 (in case of 10000), −63 (in case of 00000), . . . . That is, it can be seen that the selected level signal is quite similar to the input signal. Also, it can be seen that if a mean value is obtained from the input signals 201,202 of the channel identifier 170 delayed for each level by the equation 1, the most idealistic level value is obtained.

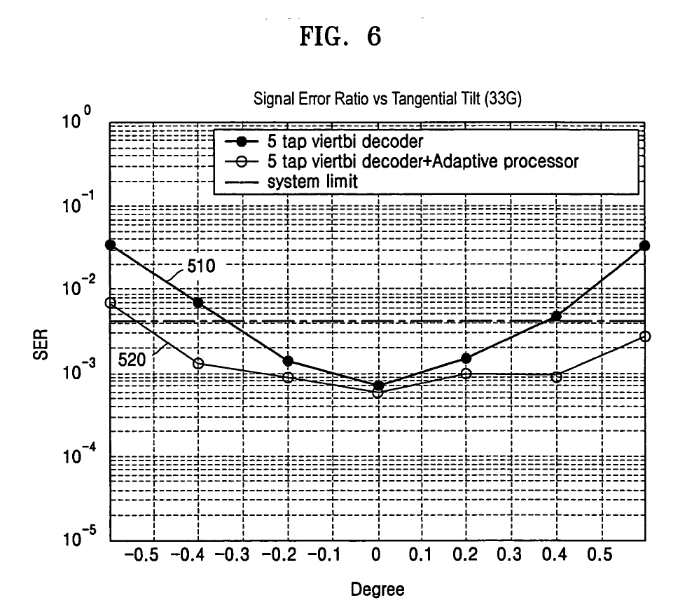

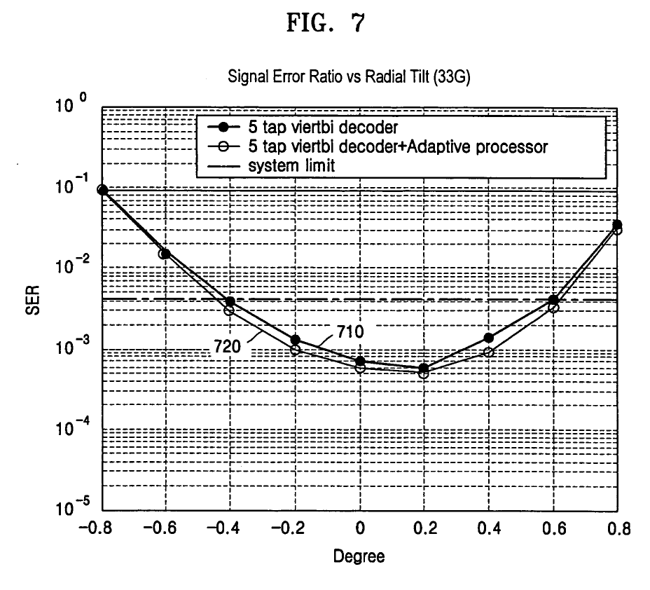

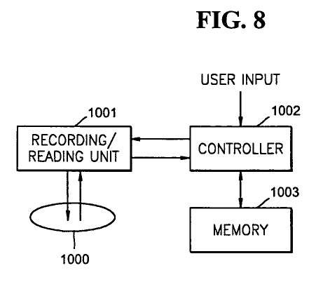

FIGS. 6 and 7 are diagrams showing the degree of signal error ratio (SER) of two types of tilts when an aspect of the present invention is used. Signal error ratios of a variety of tilt angles are shown when using the device of an aspect of the present invention, records 33 G data on a 23 G disk, and reproduces the data.

FIG. 6 shows the SER when there is tangential tilt. Referring to FIG. 6, when the adaptation processor 180 according to an aspect of the present invention is used, the SER 520 is greatly reduced from the SER 510 when the conventional 5-tap viterbi decoder 140 of FIG. 7 is used. This effect becomes much clearer as the tilt angle increases. FIG. 7 shows the SER when there is a radial tilt. It can be seen that though such remarkable effects as in the tangential tilt is not observed, the SER 720 is reduced a little from the SER 710 of the device shown in FIG. 1.

FIG. 8 is a block diagram of a recording apparatus according to an embodiment of the present invention which uses the data reproduction device of FIG. 2. Referring to FIG. 8, the recording apparatus includes a recording/reading unit 1001, a controller 1002, and a memory 1003. The recording/reading unit 1001 records data on a disc 1000, and reads the data from the disc 1000. The controller 1002 records and reproduces data according to the present invention as set forth above in relation to FIGS. 2 and 3.

While not required in all aspects, it is understood that the controller 1002 can be computer implementing the method using a computer program encoded on a computer readable medium. The computer can be implemented as a chip having firmware, or can be a general or special purpose computer programmable to perform the method.

In addition, it is understood that the disc 1000 can be any type of optical or magnetic optical disc, including but not limited to, compact discs (CDs), digital versatile discs (DVDs), Blu-ray discs, and/or Advanced Optical Discs (AOD).

While aspects of this invention have been particularly shown and described with reference to embodiments thereof, it will be understood by those skilled in the art that various changes in form and details may be made therein without departing from the spirit and scope of the invention as defined by the appended claims and equivalents thereof. The embodiments should be considered in descriptive sense only and not for purposes of limitation. Therefore, the scope of the invention is defined not by the detailed description of the invention but by the appended claims, and all differences within the scope will be construed as being included in the present invention.

According to aspects of the present invention as described above, the data reproduction device and method, which detect a reference level value capable of maximizing the performance of a viterbi decoder and limit noise caused by tilt and others that may occur by the shape of a disk or a pickup apparatus, are provided.

Also, according to an aspect of the present invention, by using the viterbi decoder for which an optimum level is detected, the probability of fault operations of a signal decreases and as a result, reliable optical disk devices can be manufactured.

Aspects of the present invention can be used in a data reproduction device using a viterbi decoder as described above.

1. A data reproduction device having a viterbi decoder, comprising:
an equalizer which equalizes a predetermined frequency of an input signal to produce an output signal using a filtering coefficient;
a channel identifier which, based on the input signal of the equalizer, detects a reference level of the viterbi decoder; and
an adaptation processor which, based on the detected reference level and the input and the output signals of the equalizer, determines a new filtering coefficient to be applied to the equalizer.

2. The data reproduction device of claim 1, wherein the equalizer is a finite impulse response (FIR) filter.

3. The data reproduction device of claim 1, wherein the channel identifier detects the reference level based on a delayed input signal of the equalizer.

4. The data reproduction device of claim 3, wherein the channel identifier detects the reference level by obtaining a mean value of the input signal of the equalizer and a previous reference level value.

5. The data reproduction device of claim 3, wherein the channel identifier comprises:
a selection signal generator which generates a selection signal from an output signal of the viterbi decoder;
a level selector which selects a level to be detected from the input signal of the equalizer according to the selection signal; and
a mean value filter which, for the selected level, generates a new level value based on a previous level value and the level value of the input signal input at the selected level.

6. The data reproduction device of claim 5, wherein the selection signal generator generates a selection signal by multiplexing a signal obtained by delaying the output signal of the viterbi decoder by a same number of clock signals as a number of taps of the viterbi decoder.

7. The data reproduction device of claim 5, wherein the mean filter is a low pass filter.

8. The data reproduction device of claim 5, wherein the mean filter detects the reference level value according to the following equation:
reference level value=previous level value+(delayed input signal−previous level value)/constant

9. The data reproduction device of claim 5, wherein the adaptation processor detects a reference level according to a least mean square (LMS) method.

10. The data reproduction device of claim 5, wherein the adaptation processor determines the new filtering coefficient to be applied to the equalizer, based on a difference between the output signal of the equalizer and the detected level.

11. The data reproduction device of claim 9, wherein the adaptation processor determines the new filtering coefficient to be applied to the equalizer according to the following equation:
W_{K+1}=Wₖ+2μ eₖ Xₖ
where W_{K+1} denotes the new filtering coefficient of the equalizer, Wₖ denotes a previous filtering coefficient of the equalizer before an update, p denotes a follow-up speed, eₖ denotes an error signal (error signal=detected level value−output of the equalizer), and Xₖ denotes the input signal of the equalizer.

12. A data reproduction method using a viterbi decoder, comprising:
equalizing a predetermined frequency of an input signal using an equalizer to produce an output signal according to a filtering coefficient;
based on the input signal of the equalizer, detecting a reference level of the viterbi decoder in identifying a channel; and
based on the detected reference level, and the input and output signals of the equalizer, determining a new filtering coefficient to be applied to the equalizer.

13. The data reproduction method of claim 12, wherein the equalizing is implemented by an Finite Impulse Response (FIR) filter.

14. The data reproduction method of claim 12, wherein the identifying of a channel comprises:
detecting the reference level based on a delayed input signal of the equalizer.

15. The data reproduction method of claim 14, wherein the identifying a channel comprises:
obtaining a mean value of the input signal of the equalizer and a previous reference level value to detect the reference level.

16. The data reproduction method of claim 14, wherein the identifying of the channel comprises:
generating a selection signal from an output signal of the viterbi decoder;
selecting a level to be detected from the input signal of the equalizer according to the selection signal; and
for the selected level, generating a new level value based on a previous level value and the level value of the input signal input in the selected level, in detecting a level value.

17. The data reproduction method of claim 16, wherein the generating of a selection signal comprises:
generating a selection signal by multiplexing a signal obtained by delaying the output signal of the viterbi decoder for a same number of clock signals as a number of taps of the viterbi decoder.

18. The data reproduction method of claim 16, wherein the detecting of a level value is performed by obtaining a mean value through a low pass filter.

19. The data reproduction method of claim 16, wherein the detecting of a level value comprises:
detecting a reference level according to the following equation:
reference level value=previous level value+(delayed input signal−previous level value)/constant

20. The data reproduction method of claim 12, wherein the generating of the new filtering coefficient comprises:
detecting a reference level according to a least mean square (LMS) method.

21. The data reproduction method of claim 20, wherein the generating of the new filtering coefficient comprises:
determining the new filtering coefficient to be applied to the equalizer, based on a difference between the output signal of the equalizer and the detected level.

22. The data reproduction device of claim 21, wherein the generating of the new filtering coefficient comprises:
determining the new filtering coefficient of the equalizer according to the following equation:
W_{K+1}=Wₖ+2μ eₖ Xₖ
where W_{K+1} denotes the new filtering coefficient of the equalizer, Wₖ denotes a previous coefficient of the equalizer before update, μ denotes a follow-up speed, eₖ denotes an error signal (error signal=detected level value−output of equalizer), and Xₖ denotes an input signal of the equalizer.
